(19) United States
(12) Patent Application Publication
(10) Pub. No.: US 2012/0036981 A1
(43) Pub. Date: Feb. 16, 2012

(54) ADJUSTMENT OF FAMILARITY IN A PLAYLIST THROUGH A SLIDER

(76) Inventor: DAVID HYMAN, Kensington, CA (US)

(21) Appl. No.: 13/025,997

(22) Filed: Feb. 11, 2011

Related U.S. Application Data
(60) Provisional application No. 61/303,329, filed on Feb. 11, 2010.

(51) Int. Cl. G10H 7/00

(52) U.S. Cl. 84/609

(57) ABSTRACT

Several methods and a system of an adjustment of familiarity in a playlist through a slider are disclosed. In one embodiment, a user may enter a particular artist or a song name through a keyboard. Once an artist or song is entered the user may be allowed to slide a slider from one end of the spectrum to the other end using a tuner. One end of the spectrum may denote the songs known to the user and the other end of the spectrum may denote the songs unknown to the user. The songs chosen by the user and the user's song selection history may be retrieved from a database module and displayed as a list of unknown songs. The list of unknown songs may be compared with the other songs in the database and a list of similar songs based on the user's seed may be generated as unknown songs.

### CLAIM OF PRIORITY

This application claims priority from U.S. Provisional application No. 61/303,329 titled “ADJUSTMENT OF FAMILIARITY IN A PLAYLIST THROUGH A SLIDER” filed on Feb. 11, 2010.

### FIELD OF TECHNOLOGY

This disclosure relates generally to an enterprise method, a technical field of software and, in one example embodiment to an adjustment of familiarity in a playlist through a slider.

### BACKGROUND

Music devices include radio, Compact Disk (CD) players, Digital Versatile Disk (DVD) players, iPods, etc. Music devices like radio may not provide music that a user wants to hear, therefore discouraging the user to use the radio. In contrast, CD players and DVD players require CDs or DVDs that may be require space to store safely. Also, the CDs and DVDs may provide limited songs of a particular artist or a particular album. The user may lose the CDs and DVDs due to damages, improper management, etc. In addition, internet enabled devices that play music such as a computer and mobile devices may require the user to create a playlist by searching a specific song of an artist, track, etc. The user may not have the time and patience to create playlists.

### SUMMARY

Disclosed are a method, an apparatus and/or a system of adjustment of familiarity in a play list through a slider.

In one aspect, a method of a music device includes presenting a list of a seed data to a user of a music device and selecting a portion of the seed data based on a preference of a user. The music device is configured to determine an identity of a primary song based on a match between the primary song and the preference of the user. The method also includes providing the user streaming access to the primary song in a database and retrieving a song selection history of the user from the database. The music device is further configured to determine an identity of a secondary song as one of a secondary song that is known to the user and a secondary song that is not known to the user based on a match between the secondary song and the song selection history of the user. A playlist is generated based on a preference of the user to hear one of a plurality of the secondary songs that are known to the user and a plurality of the secondary songs that are not known to the user. The method also includes updating the playlist based on a preference of the user to hear a given number of repetitions of a specific seed data.

The method of the music device may include the preference of the user to hear one of a plurality of the secondary songs that are known to the user and a plurality of the secondary songs that are not known to the user is indicated by sliding an awareness slider tool to a desired point along one of a vertical, horizontal, and a diagonal axis line. A method of a music device may include selecting the primary song based on the seed data selected by the user. The seed data may be one of a seed artist, a seed album, and a seed song, to provide the user control of the primary song. The method of the music device may also include the user moving the awareness slider to update the playlist while the user is currently listening to the playlist. The preference of the user to hear the given number of repetitions may be indicated by sliding a frequency slider tool to a desired point along one of a vertical, horizontal, and a diagonal axis line.

In another aspect, a system includes a database to store a seed data and a collection of songs. The system also includes a music server to generate a playlist based on a preference of a user to hear one of a plurality of songs that are known to the user and a plurality of songs that are not known to the user. The system further includes a music device, comprising a user interface to input a seed data and a familiarity module to determine whether a song is a song known to the user or a song not known to the user. A network is configured to enable communication between the music server and the music device.

In yet another aspect, the music device may be one of a mobile device, a radio, a computer, a television, and a car radio relay station to transmit a song through the network to the music device. The relay station may transmit the song to a wireless transmitter through a satellite. The user interface may further include an input medium to input the seed data. The input medium may be one of a touch screen, a keyboard, a button and an external input device. The user interface may further include an awareness slider tool that allows a user to choose one of a plurality of songs that are familiar to the user and a plurality of songs that are not familiar to the user by moving the awareness slider tool to a desired point along one of a vertical, horizontal, and a diagonal axis line. The user interface may further include a frequency slider tool to generate a playlist based on a preference of the user to hear a given number of repetitions of a specific seed data. The preference of the user to hear the given number of repetitions may be indicated by sliding a frequency slider tool to a desired point along one of a vertical, horizontal, and a diagonal axis line. The seed data may be one of a seed artist, a seed album, and a seed song, to provide the user control of the primary song.

In yet another aspect, a method of a music device includes presenting a list of a seed data to a user of a music device and selecting a portion of the seed data based on a preference of a user. An identity of a primary song is determined based on a match between the primary song and the preference of the user and the user streaming access is provided to the primary song in a database. The method also includes retrieving a song selection history of the user from the database and determining an identity of a secondary song as one of a secondary song that is known to the user and a secondary song that is not known to the user based on a match between the secondary song and the song selection history of the user. The method also includes generating a playlist based on a preference of the user to hear one of a plurality of the secondary songs that are known to the user and a plurality of the secondary songs that are not known to the user.

In yet another aspect, the preference of the user to hear one of a plurality of the secondary songs that are known to the user and a plurality of the secondary songs that are not known to the user may be indicated by sliding an awareness slider tool to a desired point along one of a vertical, horizontal, and a diagonal axis line. The primary song may be selected based on the seed data selected by the user. The seed data may be one of a seed artist, a seed album, and a seed song, to provide the user control of the primary song. The user may move the awareness slider to update the playlist while the user is currently listening to the playlist. The preference of the user to hear the given number of repetitions may be indicated by sliding a frequency slider tool to a desired point along one of a vertical, horizontal, and a diagonal axis line. The user may move the frequency slider to update the playlist while the user is currently listening to the playlist.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1A is a schematic view illustrating a music device displaying a playlist of known songs and unknown songs, according to one embodiment.

FIG. 1B is a schematic view illustrating a music device displaying a playlist of known artists and unknown artists, according to one embodiment.

FIG. 2 is a system view illustrating relaying of songs to different music playing devices, according to one embodiment.

FIG. 3A is a system view illustrating communication between a music device and a music server through a network, according to one embodiment.

FIG. 3B is an exploded view of the familiarity module 312 illustrated in FIG. 3A, according to one embodiment.

FIG. 4 is a system view illustrating different layers of a music device, according to one embodiment.

FIG. 5 is a system view illustrating an exploded view of the music device layers illustrated in FIG. 4, according to one embodiment.

FIG. 6 is a flow chart that illustrates generation of a known song playlist and unknown song playlist using a slider, according to one embodiment.

FIG. 7 is a diagrammatic system view of a data processing system in which any of the embodiments disclosed herein may be performed, according to one embodiment.

FIG. 8 is a process flow diagram detailing the operations involved in a method of a music device, according to one embodiment.

FIG. 9 is a process flow diagram detailing the operations involved in a method of a music device, according to one embodiment.

Other features of the present embodiments will be apparent from the accompanying Drawings and from the Detailed Description that follows.

### DETAILED DESCRIPTION

Several methods and a system of an adjustment of familiarity in a playlist through a slider are disclosed. Although the embodiments have been described with reference to specific example embodiments, it will be evident that various modifications and changes may be made to these embodiments without departing from the broader spirit and scope of the various embodiments.

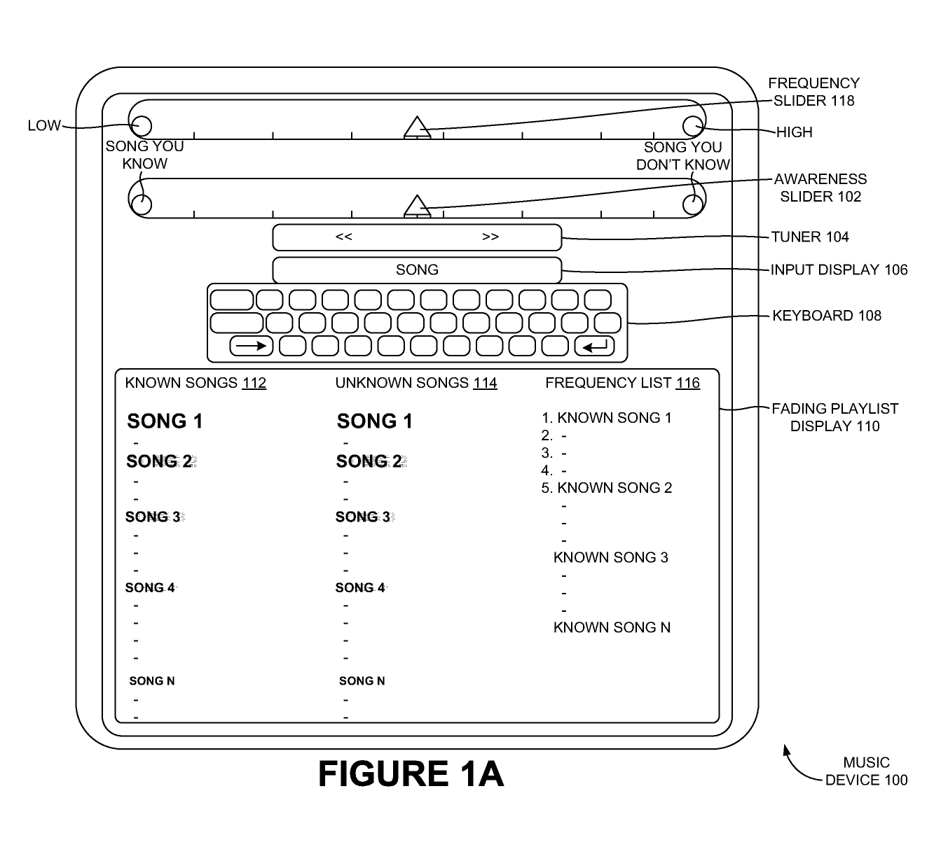

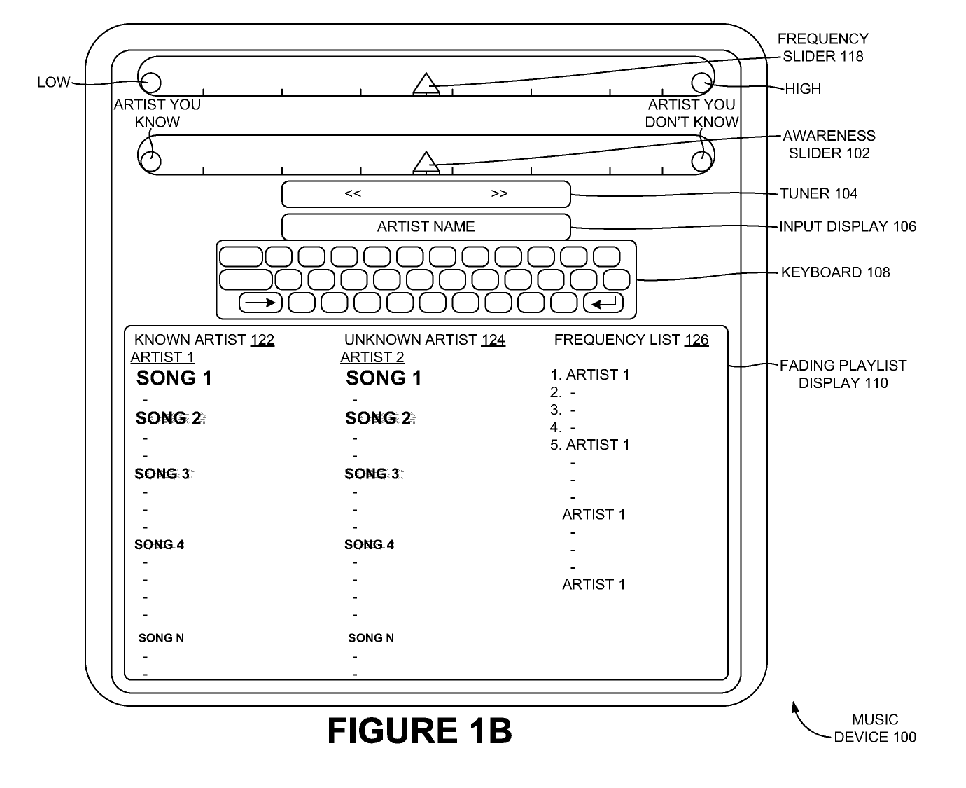

FIG. 1A is a schematic view illustrating a music device displaying playlist of known songs and unknown songs, according to one embodiment.

In one or more embodiments, a music device 100 may be used to select and play the songs based on selection criteria. The songs may be selected based on a particular artist, a genre, type of music, time frame, etc. In an alternative embodiment, the music device 100 may be embedded in a mobile device, an automobile, a television, etc.

In another embodiment, a user may enter a particular song name (e.g., seed data) through a keyboard 108 (e.g., a touch screen keyboard, a laser keyboard, a switch keyboard, etc.). The information entered through the keyboard 108 may be displayed on an input display 106. Once the seed data (e.g., song) is entered the user may be allowed to slide an awareness slider 102 from one end of a spectrum to the other end of the spectrum using a tuner 104. One end of the spectrum may signify the songs known to the user and the other end of the spectrum may signify the songs unknown to the user. In yet another embodiment the user may slide a frequency slider 118 to select the number of repetitions of a favorite song. The tuner 104 may be used to slide the sliders (e.g., awareness slider 102 and/or the frequency slider 118) for selecting the songs.

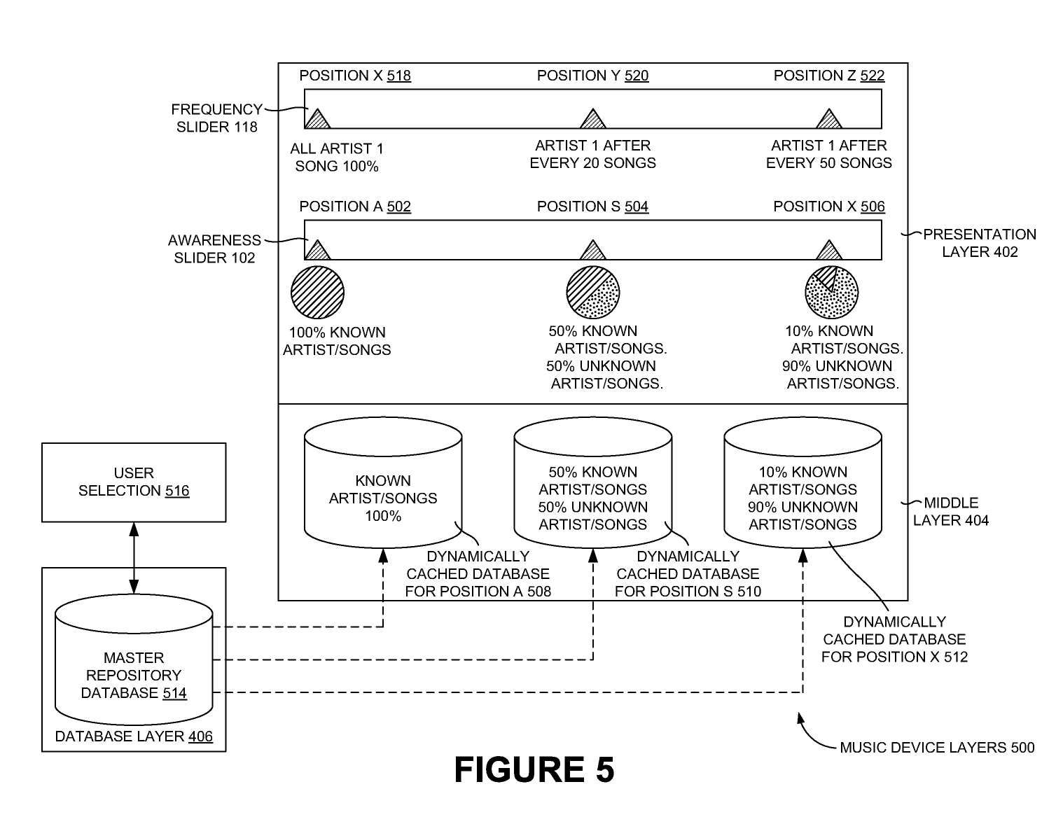

Once the user has made a selection, the songs chosen by the user and the user's song selection history may be retrieved from a master repository database (e.g., a master repository database 514 of FIG. 5) and stored in a cached database to be displayed as a list of known songs 112 and unknown songs 114. The list of known songs 112 may be compared with the other songs in the database and the list of unknown songs 114 may be generated. The known songs 112 and the unknown songs 114 may be displayed on a fading playlist display 110 as illustrated in FIG. 1A. In addition, the fading playlist display 110 may also display a frequency list 116 which may display a list of songs in which the user's favorite song may be repeatedly played based on the position of the frequency slider 118. One end of the frequency slider 118 may denote low frequency and another end of the frequency slider 118 may denote high frequency.

FIG. 1B is a schematic view illustrating a music device displaying playlist of known artist and unknown artist, according to one embodiment.

In one embodiment, a user may enter a particular artist through the keyboard 108. Once the seed data (e.g., artist and/or song) is entered, the user may be allowed to slide the awareness slider 102 from one end of a spectrum to the other end of the spectrum using the tuner 104. One end of the spectrum may signify the songs of an artist known to the user and the other end of the spectrum may signify the songs of an artist unknown to the user. In yet another embodiment, the user may slide the frequency slider 118 to select a frequency of a favorite artist song.

A playlist known artist 122 may include the songs of an artist selected by the user. The songs of an unknown artist may be displayed in a playlist unknown artist 124 as illustrated in FIG. 1B. In addition, the fading playlist display 110 may also display a frequency list 126 which may display a list of songs in which a favorite artist song is repeatedly played in between the similar songs.

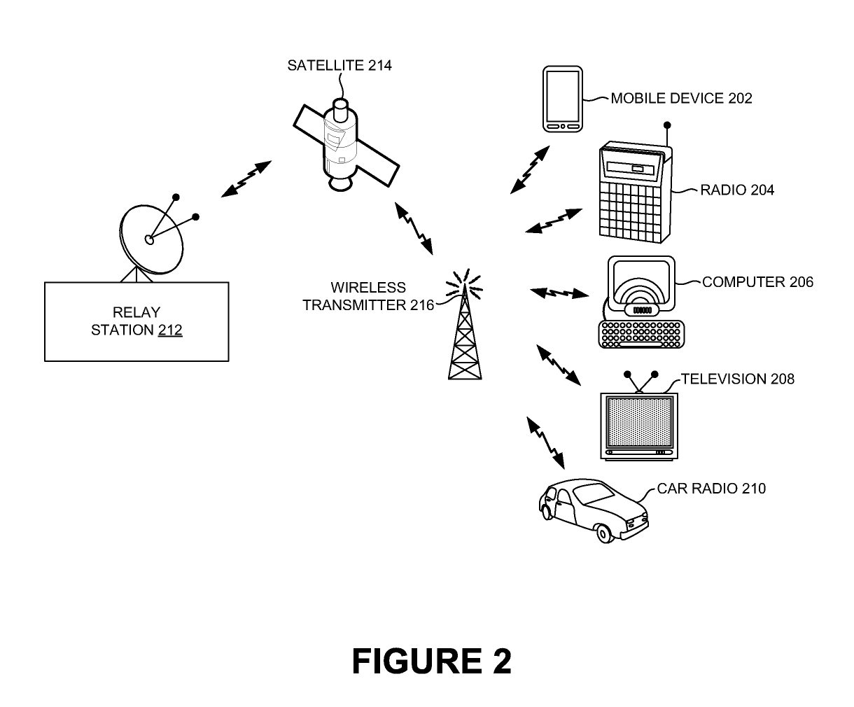

FIG. 2 is a system view illustrating relaying of songs to different music playing devices, according to one embodiment.

In one embodiment, a relay station 212 may transmit songs through a satellite network to the different music playing devices (e.g., mobile device, radio, computer, television, car radio, etc.). The relay station 212 may transmit the songs to a wireless transmitter 216 through a satellite 214. Further, the wireless transmitter 216 may transmit the songs to a mobile device 202, a radio 204, a computer 206, a television 208, or a car radio 210.

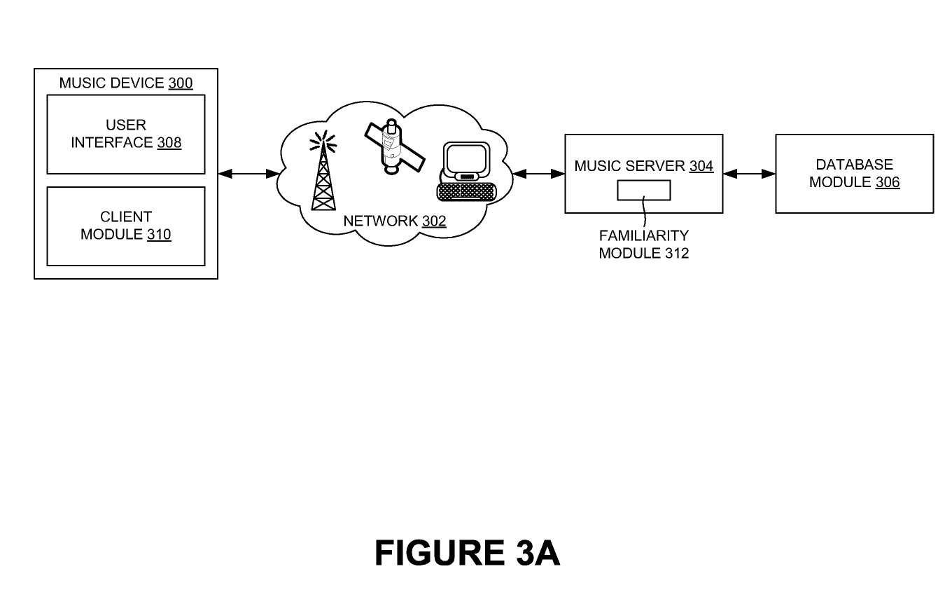

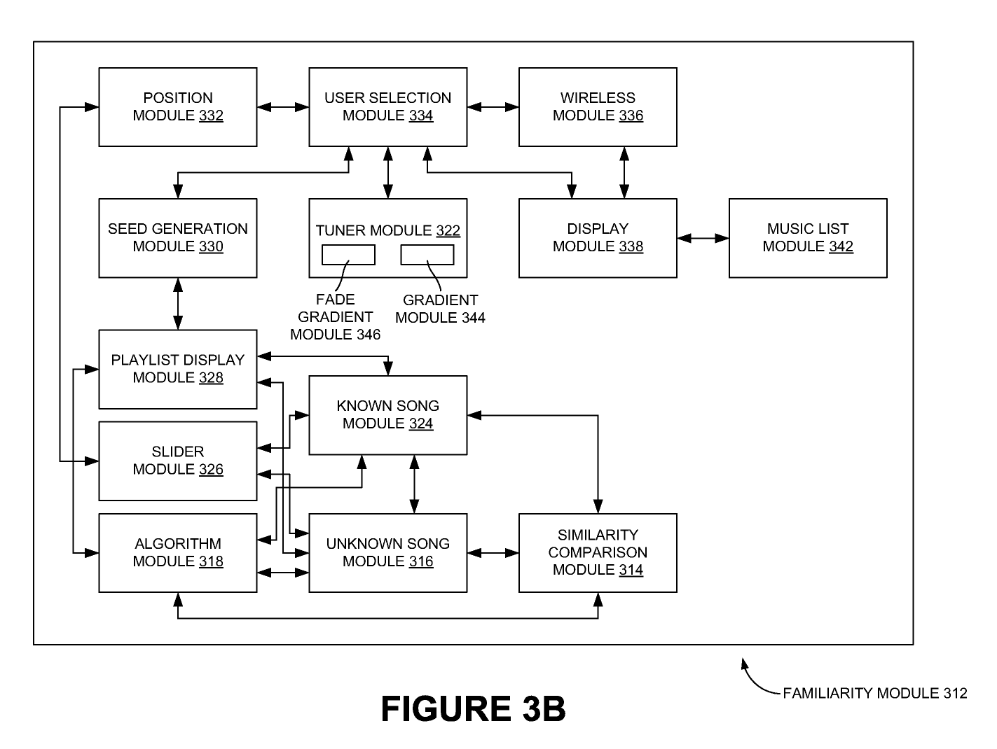

FIG. 3A is a system view illustrating communication between a music device and a music server through a network, according to one embodiment.

In one embodiment, a user may request for a song through a user interface 308 of a music device 300. The user may select a song based on an artist, genre, type of music, etc. The user request may be communicated to a music server 304 through a network 302. The network 302 may include LAN, internet, satellite communication network, etc. In one or more embodiments, the music device 300 may be associated with the user interface 308 and a client module 310.

The music server may process the user's request and fetch the songs from a database module 306. Further, the music server 304 may include the familiarity module 312 which may determine the familiar songs and unfamiliar songs by comparing with the user's request history. The database module 306 may include a master repository of songs and artists. The music server 304 may provide the songs obtained from the database module 306 to the music device 300 through the network 302.

FIG. 3B is an exploded view of the familiarity module 312 illustrated in FIG. 3A, according to one embodiment.

In one or more embodiments, the familiarity module 312 may include a user selection module 334 communicating to a position module 332, a seed generation module 330, a wireless module 336, a display module 338, and a tuner module 322. In another embodiment, a user may input a song name and/or an artist name (e.g., seed data) through the keyboard 108 as illustrated in FIG. 1 and the display module 338 may display the user's input on the input display 106. Further, the seed generation module 330 may generate the requested seed and a playlist display module 328 may display the requested song in the playlist display 110. The playlist display module 328 may obtain the songs from a known song module 324 and/or unknown song module 316. Before displaying the playlist on the playlist display, the playlist display module 328 may algorithmically compare the input song using an algorithm module 318 and a similarity comparison module 314 and determine the similar songs based on the user's input. The algorithm module 318 may be communicatively coupled to the known song module 324, the unknown song module 316 and/or the similarity comparison module 314.

In one or more embodiments, a user may also select a song by sliding the sliders (e.g., awareness slider 102 and/or the frequency slider 118) using a slider module 326. Based on the position of the slider indicated in a position module 332, the algorithm module 318 may determine whether the tuned song is a known song or an unknown song. If the user has requested for a similar song of an artist, the similarity comparison module 314 may determine a similar song. The similarity comparison module 314 may be communicatively coupled to the known song module 324, and/or the unknown song module 316.

In another embodiment, the songs of the known song module 324 and the unknown song module 316 may be obtained from the database module 306. A music list module 342 of the familiarity module 312 may list the songs that are frequently played by a user. The songs frequently played by a user may be displayed in the frequency list 116. A tuner module 322 may tune the font colors of the displayed lists on the playlist display 110. The font color of the recently played songs may be graded with high intensity using a gradient module 344 and the other songs may be displayed with faded font color using a fade gradient module 346.

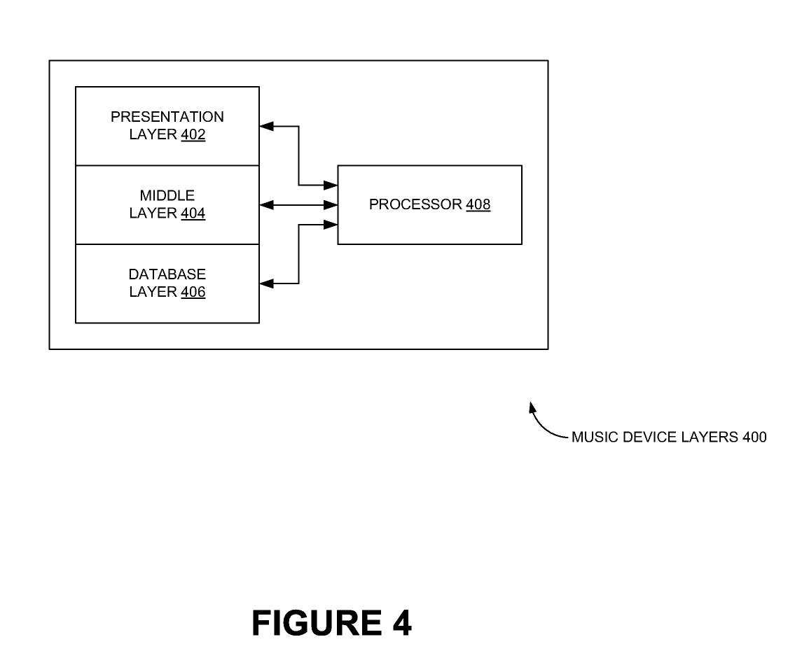

FIG. 4 is a system view illustrating different layers of a music device, according to one embodiment.

In one embodiment, music device layers 400 may include a presentation layer 402, a middle layer 404, and a database layer 406. The presentation layer 402 may present a list of known songs and unknown songs on the playlist display 110. In addition, the presentation layer 402 may provide the awareness slider 102 that may enable a user to slide and select the songs (e.g., known songs and/or unknown songs). The database layer 406 may include a master repository database (e.g., the master repository database 514 as illustrated in FIG. 5) that may store songs of different artists, genre, time frame, etc.

In another embodiment, the presentation layer 402, a middle layer 404 and a database layer 406 may communicate to a processor 408. The processor 408 may process the user's request submitted through the presentation layer 402 and provide it to the middle layer 404 and database layer 406.

The middle layer 404 may connect the database layer 406 to the presentation layer 402. When a user requests a song of a particular artist through the presentation layer 402, the requested song and the other songs related to the artist may be searched in the database layer 406 and a list of known songs and unknown songs may be displayed on the presentation layer 402 (e.g., the playlist display 110 of FIG. 1).

FIG. 5 is a system view illustrating an exploded view of music device layers 500 illustrated in FIG. 4, according to one embodiment.

In one embodiment, the presentation layer 402 may illustrate the type of songs at each position of the slider (e.g., the awareness slider 102 and the frequency slider 118). For example, on the awareness slider 102, at position A 502 a user may obtain 100% known songs, at position S 504 the user may get 50% known songs and 50% unknown songs, and at position X 506 the user may get 10% known songs and 90% unknown songs. On the frequency slider 118, at position X 518 100% artist 1 songs may be played, at position Y 520 artist 1 songs may be played after every 20 songs (e.g., similar songs) and at position Z 522 artist 1 song may be played after every 50 songs.

In another embodiment, the middle layer 404 may include cache databases that may store songs based on the position of the slider. For example, a dynamically cached database for position A 508 may include 100% known songs, a dynamically cached database for position S 510 may include 50% known songs and 50% unknown songs, and a dynamically cached database for position X 512 may include 10% known songs and 90% unknown songs.

In yet another embodiment, the database layer 406 may include a master repository database 514. A user may select (e.g., user selection 516) a song and/or an artist that may be present in the master database repository 514.

When a user slides the awareness slider 102, based on the position of the slider the songs may be retrieved from the master repository database 514 and dynamically stored in the cache databases illustrated in the middle layer 404.

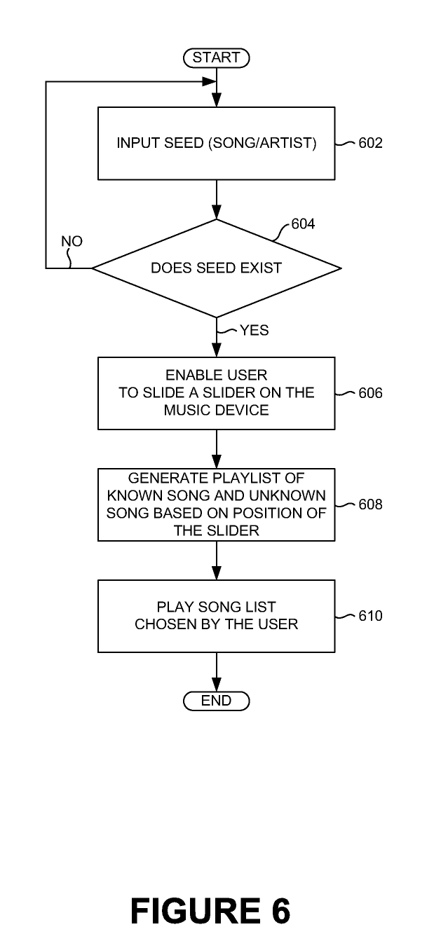

FIG. 6 is a flow chart that illustrates generation of a playlist of known songs and a playlist of unknown songs using a slider, according to one embodiment.

In operation 602, a seed (e.g., a song and/or an artist) may be input by a user using the keyboard 108. In operation 604, it may be determined whether the input seed exists in the master repository database 514 of the database layer 406. If the input seed does not exist, then operation 602 may be repeated again and, if the input seed exists in the master repository database 514, then operation 606 may be performed. In operation 606, the user may be enabled to slide the slider (e.g., the awareness slider 102 and/or the frequency slider 118) to choose a song. In operation 608, based on the position of the awareness slider 102 a playlist of known songs (e.g., known songs 112) and a playlist of unknown songs (e.g., unknown songs 114) may be generated. In operation 610, a song chosen by the user may be played continuously.

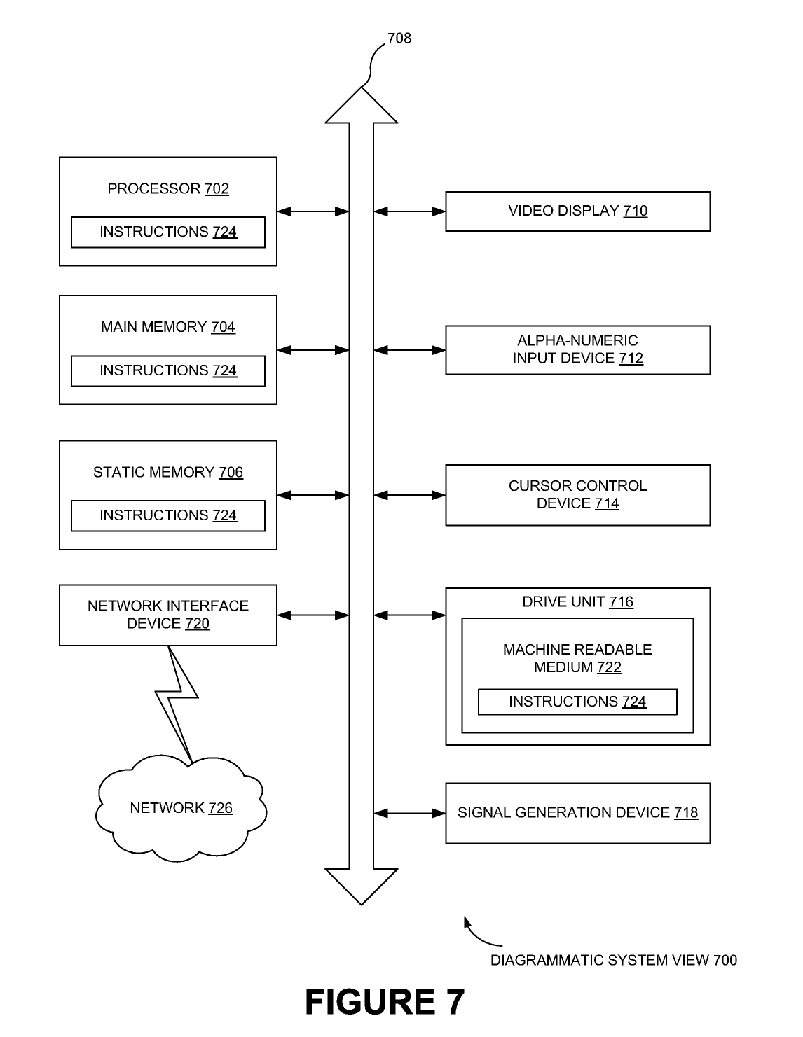

FIG. 7 is a diagrammatic system view of a data processing system in which any of the embodiments disclosed herein may be performed, according to one embodiment. Particularly, FIG. 7 illustrates a processor 702, a main memory 704, a static memory 706, a bus 708, a video display 710, an alpha-numeric input device 712, a cursor control device 714, a drive unit 716, a signal generation device 718, a network interface device 720, a machine readable medium 722, instructions 724, and a network 726, according to one embodiment.

The diagrammatic system view 700 may indicate a personal computer and/or the data processing system in which one or more operations disclosed herein are performed. The processor 702 may be a microprocessor, a state machine, an application specific integrated circuit, a field programmable gate array, etc. (e.g., Intel® Pentium® processor). The main memory 704 may be a dynamic random access memory and/or a primary memory of a computer system.

The static memory 706 may be a hard drive, a flash drive, and/or other memory information associated with the data processing system. The bus 708 may be an interconnection between various circuits and/or structures of the data processing system. The video display 710 may provide graphical representation of information on the data processing system. The alpha-numeric input device 712 may be a keypad, a keyboard and/or any other input device of text (e.g., a special device to aid the physically handicapped).

The cursor control device 714 may be a pointing device such as a mouse. The drive unit 716 may be the hard drive, a storage system, and/or other longer term storage subsystem. The signal generation device 718 may be a bios and/or a functional operating system of the data processing system. The network interface device 720 may be a device that performs interface functions such as code conversion, protocol conversion and/or buffering required for communication to and from the network 726. The machine readable medium 722 may provide instructions on which any of the methods disclosed herein may be performed. The instructions 724 may provide source code and/or data code to the processor 702 to enable any one or more operations disclosed herein.

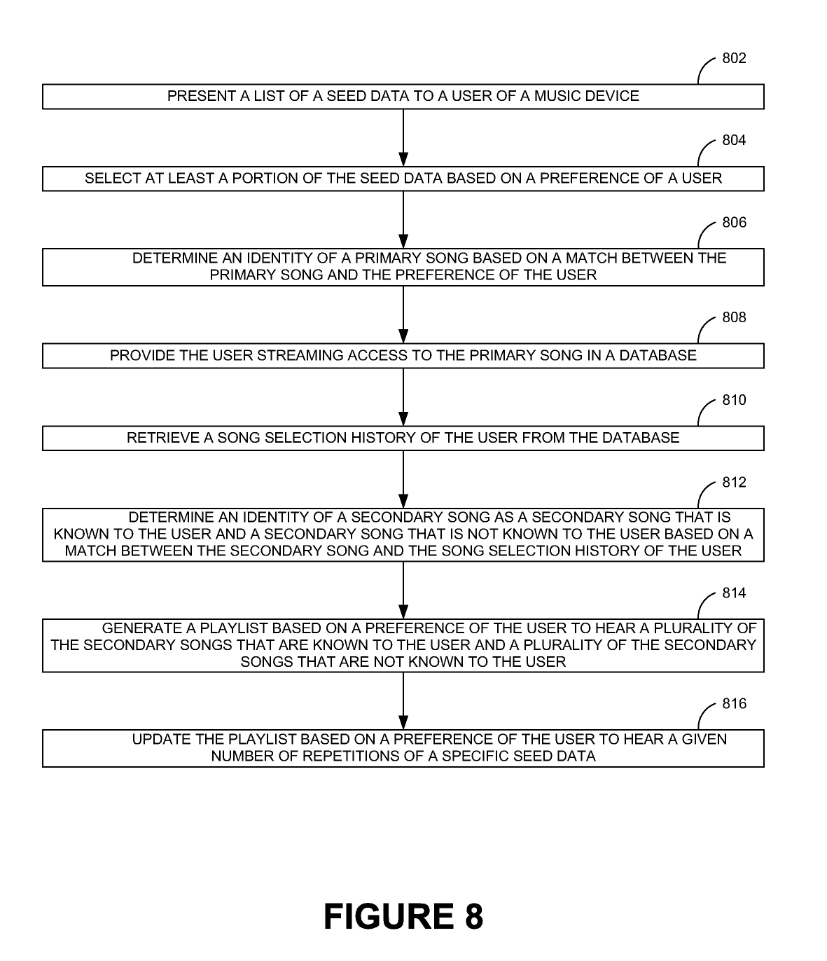

FIG. 8 shows a process flow diagram detailing the operations involved in a method of a music device, according to one embodiment. In one or more embodiments, operations 802 may involve presenting a list of a seed data to a user of a music device. In one or more embodiments, operations 804 may involve selecting a portion of the seed data based on a preference of a user. In one or more embodiments, operations 806 may involve determining an identity of a primary song based on a match between the primary song and the preference of the user. In one or more embodiments, operations 808 may involve providing the user streaming access to the primary song in a database. In one or more embodiments, operations 810 may involve retrieving a song selection history of the user from the database. In one or more embodiments, operations 812 may involve determining an identity of a secondary song as one of a secondary song that is known to the user and a secondary song that is not known to the user based on a match between the secondary song and the song selection history of the user. In one or more embodiments, operations 814 may involve generating a playlist based on a preference of the user to hear one of a plurality of the secondary songs that are known to the user and a plurality of the secondary songs that are not known to the user. In one or more embodiments, operations 816 may involve updating the playlist based on a preference of the user to hear a given number of repetitions of a specific seed data.

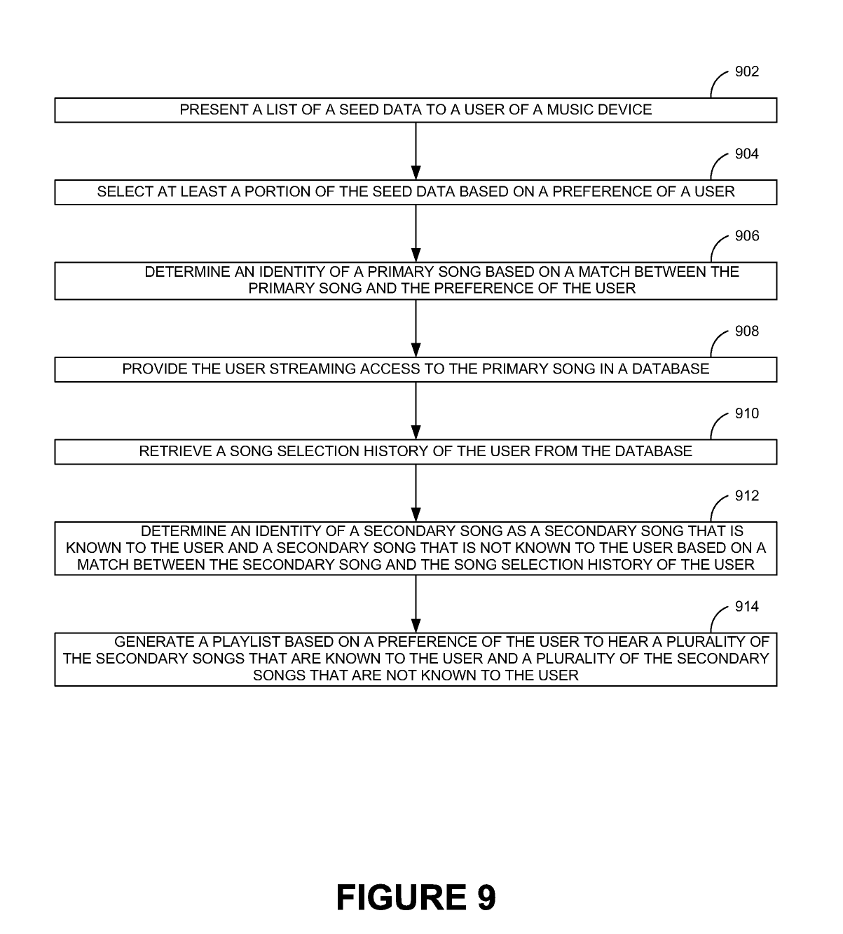

FIG. 9 shows a process flow diagram detailing the operations involved in a method of a music device, according to one or more embodiments. In one or more embodiments, operations 902 may involve presenting a list of a seed data to a user of a music device. In one or more embodiments, operations 904 may involve selecting a portion of the seed data based on a preference of a user. In one or more embodiments, operations 906 may involve determining an identity of a primary song based on a match between the primary song and the preference of the user. In one or more embodiments, operations 908 may involve providing the user streaming access to the primary song in a database. In one or more embodiments, operations 910 may involve retrieving a song selection history of the user from the database. In one or more embodiments, operations 912 may involve determining an identity of a secondary song as one of a secondary song that is known to the user and a secondary song that is not known to the user based on a match between the secondary song and the song selection history of the user. In one or more embodiments, operations 914 may involve generating a playlist based on a preference of the user to hear one of a plurality of the secondary songs that are known to the user and a plurality of the secondary songs that are not known to the user.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software or any combination of hardware, firmware, or software (e.g., embodied in a machine readable medium). For example, the various electrical structure and methods may be embodied using transistors, logic gates, and electrical circuits (e.g., application specific integrated (ASIC) circuitry or in Digital Signal Processor (DSP) circuitry).

In addition, it will be appreciated that the various operations, processes, and methods disclosed herein may be embodied in a machine-readable medium or a machine accessible medium compatible with a data processing system (e.g., a computer system), and may be performed in any order (e.g., including using means for achieving the various operations). Accordingly, the Specification and Drawings are to be regarded in an illustrative rather than a restrictive sense.

What is claimed is:

1. A method of a music device, comprising:
presenting a list of a seed data to a user of a music device;
selecting at least a portion of the seed data based on a preference of a user;
determining an identity of a primary song based on a match between the primary song and the preference of the user;
providing the user streaming access to the primary song in a database;
retrieving a song selection history of the user from the database;
determining an identity of a secondary song as at least one of a secondary song that is known to the user and a secondary song that is unknown to the user based on a match between the secondary song and the song selection history of the user;
generating a playlist based on a preference of the user to hear at least one of a plurality of the secondary songs that are known to the user and a plurality of the secondary songs that are unknown to the user; and
updating the playlist based on a preference of the user to hear a given number of repetitions of a specific seed data.

2. The method of claim 1, wherein the preference of the user to hear at least one of a plurality of the secondary songs that are known to the user and a plurality of the secondary songs that are unknown to the user is indicated by sliding an awareness slider tool to a desired point along at least one of a vertical, horizontal, and a diagonal axis line.

3. The method of claim 1, further comprising:
selecting the primary song based on the seed data selected by the user, wherein the seed data is at least one of a seed artist, a seed album, and a seed song, to provide the user control of the primary song.

4. The method of claim 2, wherein the user may move the awareness slider to update the playlist while the user is currently listening to the playlist.

5. The method of claim 1, wherein the preference of the user to hear the given number of repetitions is indicated by sliding a frequency slider tool to a desired point along at least one of a vertical, horizontal, and a diagonal axis line.

6. A system comprising:
a database to store a seed data and a collection of songs;
a music server to generate a playlist based on a preference of a user to hear at least one of a plurality of a songs that are known to the user and a plurality of a songs that are unknown to the user;
a music device, comprising a user interface to input a seed data and a familiarity module to determine whether a song is a song known to the user or a song unknown to the user; and
a network to enable communication between the music server and the music device.

7. The system of claim 6, wherein the music device is at least one of a mobile device, a radio, a computer, a television, and a car radio.

8. The system of claim 6, further comprising:
a relay station to transmit a song through the network to the music device.

9. The system of claim 8, wherein the relay station transmits the song to a wireless transmitter through a satellite.

10. The system of claim 6, wherein the user interface further comprises an input medium to input the seed data, wherein the input medium is at least one of a touch screen, a keyboard, a button and an external input device.

11. The system of claim 6, wherein the user interface further comprises an awareness slider tool that allows a user to choose at least one of a plurality of songs that are known to the user and a plurality of songs that are unknown to the user by moving the awareness slider tool to a desired point along at least one of a vertical, horizontal, and a diagonal axis line.

12. The system of claim 6, wherein the user interface further comprises a frequency slider tool to generate a playlist based on a preference of the user to hear a given number of repetitions of a specific seed data.

13. The system of claim 6, wherein the preference of the user to hear the given number of repetitions is indicated by sliding a frequency slider tool to a desired point along at least one of a vertical, horizontal, and a diagonal axis line.

14. The system of claim 6, wherein the seed data is at least one of a seed artist, a seed album, and a seed song, to provide the user control of the primary song.

15. A method of a music device, comprising:
presenting a list of a seed data to a user of a music device;
selecting at least a portion of the seed data based on a preference of a user;
determining an identity of a primary song based on a match between the primary song and the preference of the user;
providing the user streaming access to the primary song in a database;
retrieving a song selection history of the user from the database;
determining an identity of a secondary song as at least one of a secondary song that is known to the user and a secondary song that is unknown to the user based on a match between the secondary song and the song selection history of the user; and
generating a playlist based on a preference of the user to hear at least one of a plurality of the secondary songs that are known to the user and a plurality of the secondary songs that are unknown to the user.

16. The method of claim 15, wherein the preference of the user to hear at least one of a plurality of the secondary songs that are known to the user and a plurality of the secondary songs that are unknown to the user is indicated by sliding an awareness slider tool to a desired point along at least one of a vertical, horizontal, and a diagonal axis line.

17. The method of claim 15, further comprising:
selecting the primary song based on the seed data selected by the user, wherein the seed data is at least one of a seed artist, a seed album, and a seed song, to provide the user control of the primary song.

18. The method of claim 16, wherein the user may move the awareness slider to update the playlist while the user is currently listening to the playlist.

19. The method of claim 15, wherein the preference of the user to hear the given number of repetitions is indicated by sliding a frequency slider tool to a desired point along at least one of a vertical, horizontal, and a diagonal axis line.

20. The method of claim 19, wherein the user may move the frequency slider to update the playlist while the user is currently listening to the playlist.
